(19) United States
(12) Patent Application Publication
(10) Pub. No.: US 2023/0002043 A1
(43) Pub. Date: Jan. 5, 2023

(54) ORNITROPTER AND ASSOCIATED THRUST GENERATOR

(71) Applicant: ANIMAL DYNAMICS LIMITED, Oxford (GB)

(72) Inventors: Johnny PAGE, Oxford (GB); Sam SCHOEN, Oxford (GB); Alison MORRIS, Oxford (GB); Kate REYNOLDS, Oxford (GB); Ludwig RESCH, Oxford (GB); Anthony CHILDS, Oxford (GB); Adrian THOMAS, Oxford (GB); Paul TROWBRIDGE, Oxford (GB)

(73) Assignee: ANIMAL DYNAMICS LIMITED, Oxford (GB)

(21) Appl. No.: 17/780,632

(22) PCT Filed: Nov. 27, 2020
(86) PCT No.: PCT/GB2020/053025

§ 371 Date: May 27, 2022

(30) Foreign Application Priority Data
Nov. 27, 2019 (GB) 1917251.9

(51) Int. Cl. B64C 33/02; B64C 3/26; B64C 39/02

(52) U.S. Cl. CPC B64C 33/025; B64C 3/26; B64C 39/024; B64C 2201/025; B64C 3/185

(57) ABSTRACT

A thrust generator comprising: a motor (17), and a wing mounting (10), comprising a base (11) and a wing (2, 20), the base connected to the motor and configured to rotate the wing mounting about a stroke axis (13) within an angular stroke range, wherein the wing comprises a wing panel (24) having a first longitudinal edge (5) and a second longitudinal edge (6), the wing panel defining a wing surface (4) between the first and second longitudinal edges, and wherein the wing panel is configurable between: a first configuration in which the first longitudinal edge of the wing panel defines a leading edge and the second longitudinal edge of the wing panel defines a trailing edge; and a second configuration in which the second longitudinal edge of the wing panel defines a leading edge and the first longitudinal edge of the wing panel defines a trailing edge, the thrust generator being configured to rotate the wing mounting about the stroke axis in a first direction when the wing panel is in the first configuration and to rotate the base about the stroke axis in a second direction when the wing panel is in the second configuration.

Conventional unmanned aerial vehicles (UAVs) are provided with a plurality of motors, each with a rotor attached. Rotating the rotors with the motors produces lift for the UAV. The speed (and, in some UAVs, the angle) of the motors can be individually controlled, to maneuver the UAV, providing yaw, pitch and roll control.

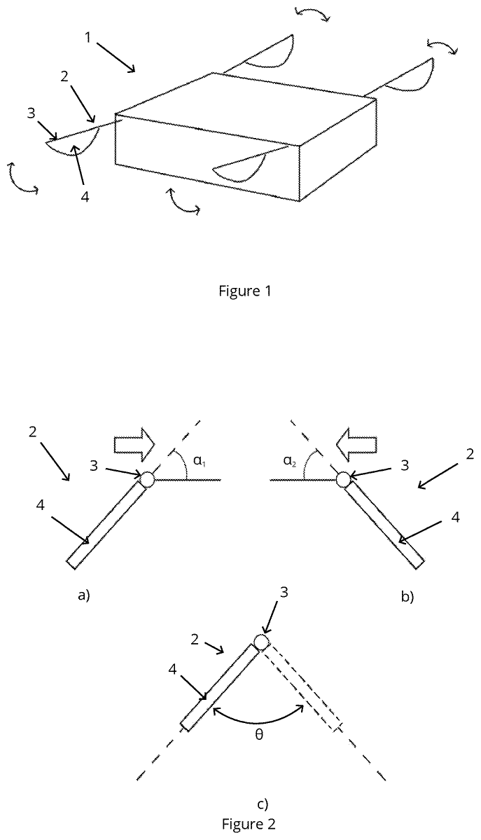

UAVs which create lift by ‘flapping’ a set of wings, rather than rotating a set of rotors, have been developed. Such a UAV 1 is schematically illustrated in FIG. 1. The spar 3 of each wing 2 may be connected to an actuator, such as a rotary drive unit (e.g. a motor) on the UAV, which is configured/driven to oscillate the wing 2 back and forth, preferably (but not essentially) within a substantially horizontal plane. A wing panel 4 extends below the spar 3. As illustrated in FIG. 2, the wing panel 4 can rotate about an axis substantially coaxial with the spar 3. Preferably, the wing panel 4 is connected to the spar 3, and the spar 3 is journaled with respect to the actuator. The wing panel 4 presents a wing surface.

The angle of attack α of the wing surface 4 is set to provide lift as the wing 2 is driven through the air (denoted by the arrows in Figures a) and b)) with an angle of attack α during each stroke of the wing 2. For each stroke, the spar 3 of the wing 2 acts as the leading edge. Although the magnitude of the angle of attack α may be substantially the same for each stroke, they are in opposing directions. Therefore, after the end of each stroke, the wing 2 needs to rotate so as to have the required angle of attack for the return stroke. The angle θ through which the wing 2 must rotate may be calculated as:

θ=180°−(α₁+α₂)

wherein α₁ is the angle of attack in the first direction, and α₂ is the angle of attack in the second (opposing) direction. For example, when α₁ and α₂ are both equal to 10°, the wing 3 must rotate through 160° when transitioning from one stroke to the next. It will be appreciated that when the angle of attack α is low, the wing 2 must rotate through a high angle θ when transitioning from one stroke to the next. The angle θ is the operational angular range of the wing 2. The wing may be mechanically limited only to rotate within the operational angular range θ. The angle of attack α may be different in each direction.

There may be no active control of the angle of the wing 2 during a stroke. The angle of the wing 2 is a consequence of the movement of air over the wing surface 4, as the wing 2 is driven through a stroke by the actuator. Consequently, when the wing needs to transition from one stroke to the next, the wing may not rotate towards the required angle of attack until there is sufficient air moving over the wing surface to cause the wing to rotate.

The rate of rotation of the wing 2 between strokes affects the amount of lift generated during the stroke. If the rate of rotation is slow, then a higher percentage of the total stroke time is taken up with rotating the wing 2 and a lower percentage of the total stroke time is taken up with the wing 2 being set at the required angle of attack α, generating lift.

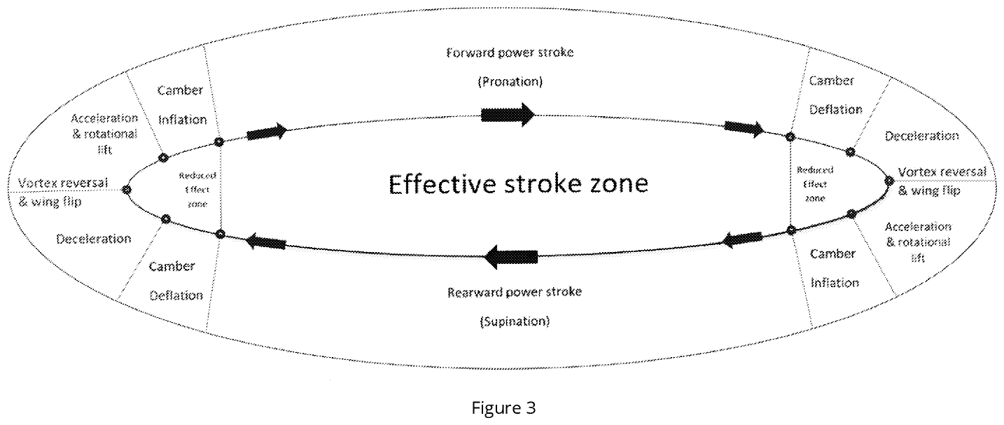

The various phases that a flapping wing 2 goes through are indicated in FIG. 3. It will be appreciated that the time spent in the power strokes should be maximised, and the time spent rotating the wing 2 (referred to as ‘reduced effect zone’ in FIG. 3) should be minimised.

The present invention seeks to address at least one of the above problems.

Accordingly, the present invention provides a wing comprising a wing panel having a first longitudinal edge and a second longitudinal edge, the wing panel defining a wing surface between the first and second longitudinal edges, wherein the wing is configured such that, in use, either the first or second longitudinal edge may define a leading edge of the wing to generate lift.

In at least one embodiment, the wing panel is substantially symmetrical.

In at least one embodiment, the wing panel is symmetrical about a line of symmetry which is substantially equidistant from the first and second longitudinal edges.

In at least one embodiment, the wing panel is substantially planar.

In at least one embodiment, the wing panel is substantially non-planar.

In at least one embodiment, the wing panel comprises a first spar and a second spar and a membrane extending between the first and second spars, wherein the first and second spars define said first and second longitudinal edges respectively.

In at least one embodiment, the wing panel is flexible.

In at least one embodiment, the first longitudinal edge is non-parallel to the second longitudinal edge.

There is also provided a wing mounting, comprising:
a base;
a wing bracket pivotally mounted to the base, configured to rotate relative to the base about a tilt axis within an angular tilt range; and
a wing according to the invention, attached to the wing bracket.

In at least one embodiment, the wing is offset from the tilt axis.

In at least one embodiment, the centre of gravity of the wing bracket and wing assembly is offset from the tilt axis.

There is also provided a thrust generator comprising:
a motor,
a wing mounting according to the invention, wherein the base is connected to the motor and configured to rotate about a stroke axis within an angular stroke range.

In at least one embodiment, the wing panel is configurable between:
a first configuration in which the first longitudinal edge of the wing panel defines a leading edge and the second longitudinal edge of the wing panel defines a trailing edge; and
a second configuration in which the second longitudinal edge of the wing panel defines a leading edge and the first longitudinal edge of the wing panel defines a trailing edge.

In at least one embodiment, the thrust generator is configured to rotate the base about the stroke axis in a first direction when the wing panel is in the first configuration and to rotate the base about the stroke axis in a second direction when the wing panel is in the second configuration.

In at least one embodiment, in the first configuration the wing panel has a first angle of attack and in the second configuration the wing panel has a second angle of attack.

In at least one embodiment, the magnitude of the first angle of attack is substantially the same as the magnitude of the second angle of attack.

In at least one embodiment, the operational angular tilt range of the wing bracket is substantially equal to the sum of the first angle of attack and the second angle of attack.

In at least one embodiment, the motor is configured to oscillate the wing mounting about the stroke axis.

Embodiments of the present invention will now be described, by way of non-limiting example only, with reference to the Figures in which:

FIG. 1 schematically illustrates an unmanned aerial vehicle (UAV) having a set of flapping wings;

FIGS. 2a to c schematically illustrate the motion of the wing of the UAV of FIG. 1 in use;

FIG. 3 illustrates the phases through which a flapping wing 2 passes in use;

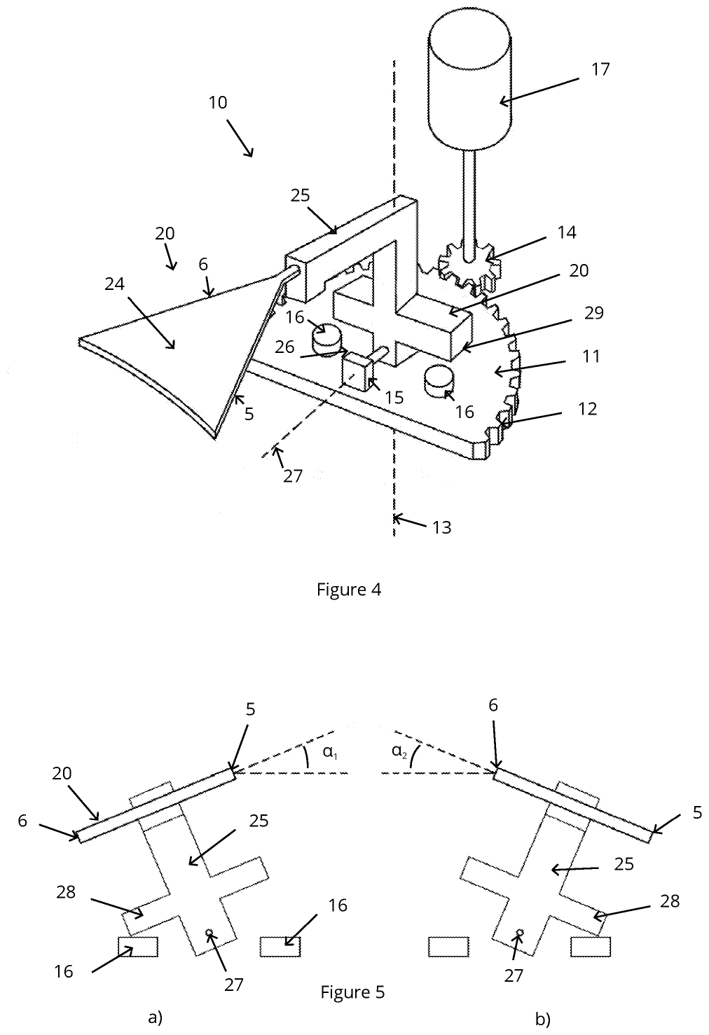

FIG. 4 schematically illustrates a thrust generator embodying the present invention;

FIG. 5 schematically illustrates a wing mounting embodying the present invention in different configurations;

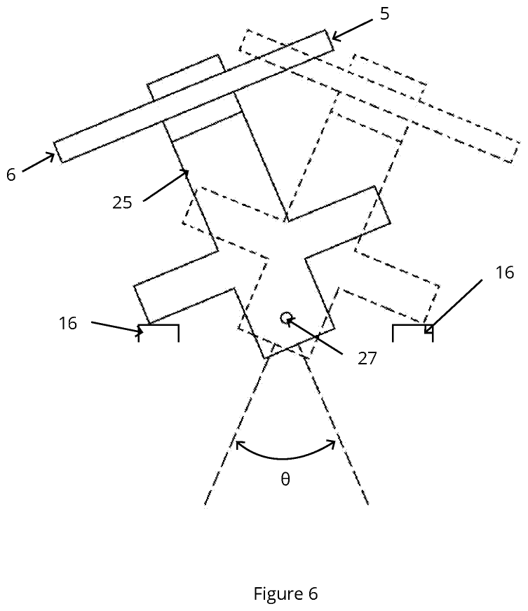

FIG. 6 schematically illustrates the angular tilt range of a wing mounting embodying the present invention; and

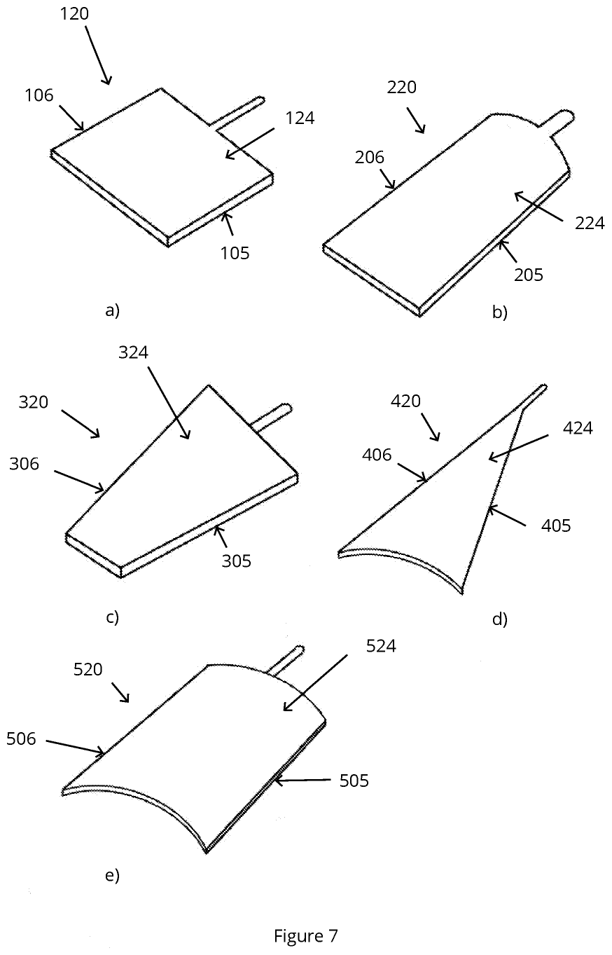

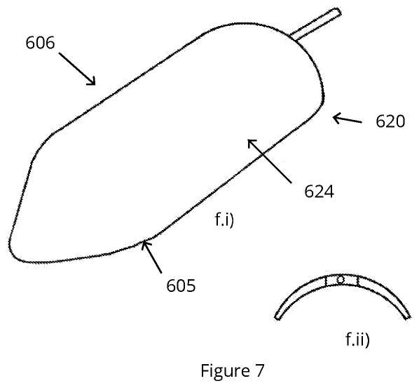

FIGS. 7a)-7f) schematically illustrate various wings embodying the present invention.

As schematically illustrated in FIG. 4, there is provided a wing mounting 10 comprising a base 11 and a wing bracket 25 which is pivotally mounted to the base 11. The base 11 may comprise a substantially semi-circular plate having teeth 12 on the circumferential perimeter. The shape is not essential. The base 11 may be mounted to the UAV so as to be pivotable about a substantially vertical stroke axis 13. A gear wheel 14 may mesh with the teeth 12. A motor 17 may be connected to the gear wheel 14, such that rotation of the gear wheel 14 causes the base 11 to rotate about the stroke axis 13. Preferably, the base 11 is caused to oscillate about the stroke axis 13 with a predetermined (adjustable) stroke rate and within a predetermined angular stroke range.

A spring mechanism may be adopted to urge the base 11 towards a particular (home) position about the stroke axis 13. The spring may be a helical spring.

The use of teeth 12, gear wheel 14 and oscillating motor 17 are not essential. Any other means to oscillate the base 11 about the stroke axis 13 may be adopted, including but not limited to direct drive rotary motor, indirect rotary drive motor, linear motor, pulleys, strings, gears, belt drive etc. In one embodiment, a mechanism may be connected between the motor and the base 11 to convert a continuous rotation of the motor into an oscillatory motion of the base 11.

The base 11 comprises two upstanding bosses 15 (one shown) and two protrusions 16 which act as mechanical stops.

The wing bracket 25 comprises a pin 26 which is rotatably received in the bosses 15 of the base 11 such that the wing bracket 25 is able to rotate about a tilt axis 27. The tilt axis 27 may be substantially perpendicular to the stroke axis 13. The tilt axis 27 may be substantially horizontal.

A wing 20 is secured to the top part of the wing bracket 25. In another embodiment, the wing 20 and bracket 25 may be integral with one another. The wing 20 comprises a wing panel 24 having a first longitudinal edge 5 and a second longitudinal edge 6, the wing panel 24 defining a wing surface between the first 5 and second 6 longitudinal edges, wherein the wing 20 is configured such that, in use, either the first 5 or second 6 longitudinal edge may define a leading edge of the wing 20 to generate lift.

The first longitudinal edge 5 and second longitudinal edge 6 are non-parallel to one another.

In the embodiment shown, the wing panel 24 is substantially symmetrical. The axis of symmetry is substantially parallel to the tilt axis 27. The line of symmetry is substantially equidistant from the first 5 and second 6 longitudinal edges. In another embodiment, the wing panel 24 may not be symmetrical.

In the embodiment shown in FIGS. 4 to 6, the wing panel 24 is substantially planar. The cross-section and/or thickness of the wing panel may be substantially uniform between the first longitudinal edge 5 and a second longitudinal edge 6. In other embodiments, the top wing surface of the wing panel 24 may differ to the bottom wing surface of the wing panel 24. The thickness of the wing panel 24 at the first longitudinal edge 5 and the second longitudinal edge 6 may be thicker than the thickness of the wing panel at a point between the first longitudinal edge 5 and second longitudinal edge 6. The surface area of the top surface of the wing panel 24 may be greater than the surface area of the lower surface of the wing panel 24. The mean camber line of the wing panel 24 may be non-planar. Consequently, the wing panel 24 may act as an aerofoil.

The planar wing 20 is secured to the wing bracket 25 such that the plane of the wing panel 24 is substantially parallel to, but offset from, the tilt axis 27. That is to say that the tilt axis 27 does not pass through the plane of the wing 20.

The wing bracket 25 further comprises an anvil section 28, the underside of which provides one or more engaging surfaces 29.

The wing bracket 25 is constrained to rotate within an operational angular tilt range θ (see FIG. 6) by the mechanical stops 16. During a stroke, as the wing 20 is moved through the air by the base 11 rotating about the stroke axis 13, the movement of the air over the wing surface of the wing panel 24 causes the wing bracket 25 to rotate about the wrist axis 27. This is because the wing panel 24 is offset from the wrist axis 27. The air acting on the wing surface imparts a force on the wing panel 24, which creates a moment arm about the wrist axis 27, causing it to rotate.

When the wing bracket 25 rotates to a maximum extent in one direction (setting the wing 20 to a first angle of attack α₁), further rotation of the wing 2 is prevented by the engaging surface 29 of the anvil 28 abutting the mechanical stop 16. See FIG. 5a).

When the wing 20 reaches the extent of the stroke, and decelerates, the air passing over the wing panel 24 reduces. At the same time, the inertia of the moving wing bracket 25 causes the wing bracket 25 to rotate about the wrist axis 27. The wing bracket 25 may continue to rotate about the wrist axis until the other engaging surface 29 of the anvil 28 abuts the other mechanical stop 16. See FIG. 5b). At this point, the base 11 may start to rotate about the stroke axis 13 in the opposing direction, with the wing 20 set at a second angle of attack α₂.

During the transition between the first α₁ and second α₂ angles of attack, the wing panel 24 may momentarily be arranged substantially horizontally.

The anvil 28 and mechanical stop 16 arrangement effectively maintains the required angle of attack α during each stroke. The anvil and/or mechanical stops 16 may be configured to set the required angle of attack of the wing 20 in each direction.

It will be noted that, to transition from the first configuration where the wing panel 24 has a first angle of attack α₁ and the second configuration where the wing panel 24 has a second angle of attack α₂, the wing bracket 25 must rotate about the wrist axis 27 by an angle θ which is substantially equal to the sum of the first angle of attack α₁ and the second angle of attack α₂.

This contrasts to the arrangement schematically illustrated in FIGS. 1 and 2, where the wing 2 must rotate through an angle equal to (180°−(α₁+α₂). Accordingly, with the arrangement shown in FIGS. 1 and 2, where the respective angles of attack are low (shallow), the wing bracket 25 must rotate through a relatively large angle between the first and second configurations of the wing. The shallower the angles of attack, the greater then angle through which the wing bracket 25 must rotate.

By comparison, with the wing mounting 10 embodying the present invention, the wing bracket 25 only needs to rotate through an angle substantially equal to the sum of the first angle of attack α₁ and the second angle of attack α₂. Conveniently, this allows the wing 20 to transition between the first and second configurations far more quickly than with the arrangement shown in FIGS. 1 and 2. By contrast to that arrangement, the angle through which the wing mounting 10 embodying the present invention must rotate between the first and second configurations reduces as the respective angles of attack reduce.

This conveniently reduces the time the wing 20 is in the reduced effect zone (FIG. 3) and maximises the effective stroke zone.

The wing 20 illustrated in FIGS. 4 to 6 is substantially planar, having substantially straight/linear longitudinal edges. This is not essential. The wing may take other forms, for example as schematically illustrated in FIG. 7.

FIG. 7a) schematically illustrates a wing 120 having a wing panel 124 which is generally square and substantially planar. The first longitudinal edge 105 may be substantially parallel to the second longitudinal edge 106.

FIG. 7b) schematically illustrates a wing 220 having a wing panel 224 which is generally rectangular and substantially planar. The first longitudinal edge 205 may be substantially parallel to the second longitudinal edge 206.

FIG. 7c) schematically illustrates a wing 320 having a wing panel 324 which is generally trapezoidal and substantially planar. The first longitudinal edge 305 is non-parallel to the second longitudinal edge 306.

FIG. 7d) schematically illustrates a wing 420 having a wing panel 424 which is generally triangular. The first longitudinal edge 405 is non-parallel to the second longitudinal edge 406. The wing panel 424 is non-planar. The wing panel 424 is curved.

FIG. 7e) schematically illustrates a wing 520 having a wing panel 524 which is generally square. The first longitudinal edge 505 is parallel to the second longitudinal edge 506. The wing panel 524 is non-planar. The wing panel 524 is curved.

FIGS. 7fi) and fii) schematically illustrate a wing 620 having a wing panel 624 having a first longitudinal edge 605 and a second longitudinal edge 606. The wing panel 624 is non-planar. The wing panel 624 is curved (as best seen in the end profile of FIG. 7fii)). The first longitudinal edge 605 and second longitudinal edge 606 are non-linear. At least some of the first longitudinal edge 605 and second longitudinal edge 606 may be linear, and the rest curved. In another embodiment, all of the first longitudinal edge 605 and second longitudinal edge 606 may be curved.

The wing panels 424 and 524 illustrated in FIGS. 7d) and e) have a single axis of curvature. In another embodiment, there may be more than one axis of curvature., for example two axes of curvature—the wing panel may be substantially convex/concave.

In the embodiments illustrated in FIGS. 4 to 7, the wing panels are shown as comprising a substantially unitary item. The wing panel may be substantially rigid.

Alternatively, a wing panel of an embodiment of the invention may be flexible.

In an alternative embodiment, the wing panel may comprise a first spar and a second spar and a membrane extending between the first and second spars, wherein the first and second spars define the first and second longitudinal edges respectively. The first and second spars may be substantially rigid, and the membrane may be at least partially flexible. The first and second spars may alternatively be at least partially flexible. The flexibility of the first and second spars may differ to the flexibility of the membrane.

The membrane may extend between the first and second spars. Alternatively, the first and/or second spar may be arranged above or below the membrane. The wing surface may extend beyond the first and/or second spars.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. thrust generator comprising:
a motor, and
a wing mounting, comprising a base and a wing, the base connected to the motor and configured to rotate the wing mounting about a stroke axis within an angular stroke range,
wherein the wing comprises a wing panel having a first longitudinal edge and a second longitudinal edge, the wing panel defining a wing surface between the first and second longitudinal edges, and
wherein the wing panel is configurable between:
a first configuration in which the first longitudinal edge of the wing panel defines a leading edge and the second longitudinal edge of the wing panel defines a trailing edge; and
a second configuration in which the second longitudinal edge of the wing panel defines a leading edge and the first longitudinal edge of the wing panel defines a trailing edge,
the thrust generator being configured to rotate the wing mounting about the stroke axis in a first direction when the wing panel is in the first configuration and to rotate the base about the stroke axis in a second direction when the wing panel is in the second configuration.

2. A thrust generator according to claim 1, wherein the wing panel is substantially symmetrical.

3. A thrust generator according to claim 2, wherein the wing panel is symmetrical about a line of symmetry which is substantially equidistant from the first and second longitudinal edges.

4. A thrust generator according to claim 1, wherein the wing panel is substantially planar.

5. A thrust generator according to claim 1, wherein the wing panel is substantially non-planar.

6. A thrust generator according to claim 1, wherein the wing panel comprises a first spar and a second spar and a membrane extending between the first and second spars, wherein the first and second spars define said first and second longitudinal edges respectively.

7. A thrust generator according to any preceding claim 1, wherein the wing panel is flexible.

8. A thrust generator according to claim 1, wherein the wing panel is substantially rigid.

9. A thrust generator according to claim 1, wherein the first longitudinal edge is non-parallel to the second longitudinal edge.

10. A thrust generator according to claim 1, wherein the wing mounting further comprises a wing bracket pivotally mounted to the base, configured to rotate relative to the base about a tilt axis within an angular tilt range, wherein the wing is attached to the wing bracket.

11. A thrust generator according to claim 10, wherein the wing is offset from the tilt axis.

12. A thrust generator according to claim 10, wherein the centre of gravity of the wing bracket and wing assembly is offset from the tilt axis.

13. A thrust generator according to claim 1, wherein in the first configuration the wing panel has a first angle of attack and in the second configuration the wing panel has a second angle of attack.

14. A thrust generator according to claim 13, wherein the magnitude of the first angle of attack is substantially the same as the magnitude of the second angle of attack.

15. A thrust generator according to claim 13, wherein the operational angular tilt range of the wing bracket is substantially equal to the sum of the first angle of attack and the second angle of attack.

16. A thrust generator according to claim 1, wherein the motor is configured to oscillate the wing mounting about the stroke axis.
